(19) United States
(12) Patent Application Publication
(10) Pub. No.: US 2008/0140802 A1
(43) Pub. Date: Jun. 12, 2008

(54) OFFSITE CENTRALIZED DATA CENTER PROVIDING CLIENT FUNCTIONALITY

(75) Inventors: Marc Levy, Woodinville, WA (US); Malcolm Erik Pearson, Kirkland, WA (US); Margaret Elisabeth Rottsolk, Seattle, WA (US); Jonathan Robert LeCroy, Redmond, WA (US); Charles McColgan, Kirkland, WA (US)

Correspondence Address: WOODCOCK WASHBURN LLP (MICROSOFT CORPORATION), CIRA CENTRE, 12TH FLOOR, 2929 ARCH STREET, PHILADELPHIA, PA, 19104-2891, US

(73) Assignee: Microsoft Corporation, Redmond, WA (US)

(21) Appl. No.: 11/608,509

(22) Filed: Dec. 8, 2006

(51) Int. Cl. G06F 15/16

(52) U.S. Cl. 709/217

(57) ABSTRACT

A server adapted to provide client functionality may include an offsite centralized data center and a local client functionality component that may be stored in the offsite centralized data center. The offsite centralized data center may remotely host the local client functionality component such that information stored in the local client functionality component appears local to a client. The server may further include a client interface that receives local client information from the client. The local client information may be replicated by the client before being received by the client interface and remotely hosted by the offsite centralized data center.

### BACKGROUND

To connect computing resources in a company or business, on-premise servers are an integral part of a network strategy. Typically, the on-premise servers function to share resources including, for example, hardware, software, and documents by making these resources centrally accessible to client computers connected to the on-premise server. Also, the on-premise servers typically function to increase security. To share resources, the on-premise servers may be driven by software such as email exchange servers to manage email distribution and document sharing applications. The document sharing applications may include, for example, integrated software applications that work on the server to provide document organization and sharing amongst client computers connected to the server. Although on-premise servers are an integral part of a network strategy, the servers require manpower to operate and do not insulate a company or business completely from risks of security breaches.

To remove some of the manpower costs and to reduce potential security breaches, services are available that transfer some of the functionality provided by the on-premise servers to an offsite location. For example, some businesses use offsite email filters to scan for potential security breaches to its on-premise network. Also, some businesses use web hosting services to host their websites or provide online systems for storing information such as documents. Whether a business uses offsite mail filters or web hosting services to access the email or documents, a user opens a web browser or a client application and accesses the email and documents via the World Wide Web adding an extra step and taking away potential valuable time to the employee. Also, to share information via the external websites, a new username and password may be necessary so that the external website may have a way to identify a user and give the user permission to view the information stored for the business on the site.

Additionally, some companies or businesses may outsource their entire server and network needs to a third party network provider. Typically, these network providers set up the business or company network, house the servers needed for the business or company network, and provide the manpower necessary to keep the network supported and running. Outsourcing the entire network may reduce the manpower and support necessary to maintain servers typically housed on-premise, but outsourcing the entire network may result in decreased speed and efficiency to the client accessing the shared resources via the servers.

### SUMMARY

According to some embodiments, a server adapted to provide functionality for a client may include an offsite centralized data center and a local client functionality component. The local client functionality component may be stored in the offsite centralized data center such that the offsite centralized data center remotely hosts the local client functionality component. The server may further include a client interface that receives local client information from a client. The local client information may be replicated by the client before being received by the client interface. The offsite centralized data may receive the local client information from the client interface.

According to additional embodiments, a method for providing server functionality includes receiving local client information at an offsite centralized data center. The local client information may be replicated by the client before being received at the offsite centralized data center. The method further includes hosting the local client information at the offsite centralized data center.

This summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 depicts an example embodiment of a server adapted to provide local client functionality;

FIG. 2 depicts another example embodiment of a server adapted to provide local client functionality;

FIG. 3 depicts an example embodiment of a flow diagram that illustrates providing local client functionality remotely according to one embodiment;

FIG. 4 depicts an example embodiment of an offsite centralized data center in communication with one or more clients;

FIG. 5 depicts an example embodiment of a flow diagram that illustrates brokering multiple clients via a centralized data center; and

FIG. 6 shows an exemplary computing environment in which aspects of the example embodiments may be implemented.

### DETAILED DESCRIPTION

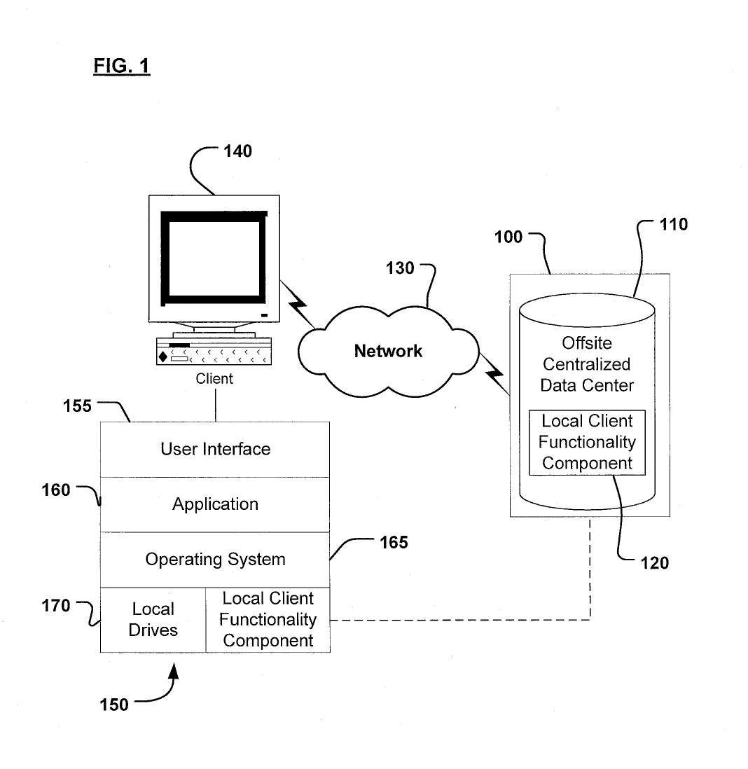

FIG. 1 depicts an example embodiment of a server 100 adapted to provide local client functionality. Server 100 may include a computer that provides the ability to share resources remotely to clients. Server 100 may further include an offsite centralized data center 110. Offsite centralized data center 110 may be, for example, an enhanced database that may include a local client functionality component 120 stored therein. Offsite centralized data center 110 may be networked with one or more offsite centralized data centers. Networking multiple offsite centralized data centers may provide an increased ability to remotely host additional client functionality. Additionally, the networked offsite centralized data centers may function like distributed databases function when networked together. Offsite centralized data center 110 may store information in local client functionality component 120 in a systematic way such that it may be easily viewed by a program running on a client computer. Local client functionality component 120 implemented in offsite centralized data center 110 may have, for example, information such as domain names, passwords, email addresses, email messages, calendars, and contacts stored therein. Local client functionality component 120 may also have, for example, additional data such as word processing documents or software programs stored therein.

Offsite centralized data center 110 including local client functionality component 120 may function to remotely build functionality that may complement an on-premise application, such as an email program, for a client. For example, offsite centralized data center 110 may remotely host features such as virus protection, spam filtering and email archiving used by the on-premise application and viewed by the client. These remotely hosted features that may be stored in local client functionality component 120 may be managed by offsite centralized data center 110 rather than by the client. Remotely hosting these features at offsite centralized data center 110 may also reduce needless traffic to the client. For example, local client functionality component 120 may include valid user information. If email is filtered remotely by offsite centralized data center 110, when email gets sent to an invalid user (e.g. a user not stored in local client functionality component 120), offsite centralized data center 110 may block the email. Because this feature is done remotely, the email may be filtered at offsite centralized data center 110, and thus unnecessary traffic to the client may be avoided.

Additionally, offsite centralized data center 110 may remotely host features of instant messaging applications. For example, offsite centralized data center 110 may host features to add value to an on-premise instant messaging application such as virus protection for attachments sent via an instant message to a client.

Offsite centralized data center 110 may also remotely store groups, recipients, and/or domains for a client in, for example, local client functionality component 120. With this information stored in, for example, local client functionality component 120, offsite centralized data center 110 may enforce policies sent by clients regarding the stored information. For example, if a client may want to block emails from a particular domain, the client may send this policy to offsite centralized data center 110. Offsite centralized data center 110 may enforce the received policy remotely to the information it hosts for the client. Additionally, offsite centralized data center 110 may enforce archiving policies required by a client such as, for example, storing emails for a set amount of time or deleting emails within a set amount of time. Similarly, offsite centralized data center 110 may manage special configurations generated by a client for different teams within an organization, such as, safe sender lists and team lists. When managing team lists, offsite centralized data center 110 may prevent one team from accessing information such as, emails or data, of another team. Thus, offsite centralized data center 110 may serve as gateway that may remotely host a multitude of information without the need for the client to deploy multiple solutions to integrate hosting this information.

As shown in FIG. 1, a client 140 may be in communication with offsite centralized data center 110 via a network 130. Offsite centralized data center 110 may remotely host local client functionality component 120 such that local client functionality component 120 appears local to client 140 using, for example, a hierarchy 150 thereby reducing the impact on client 140. For example, client 140 may include a computer with a user interface 155 that client 140 may see. Running user interface 155 may be a software application 160. Software application 160 may access local drives 170 on the computer for client 140 as well local client functionality component 120 via an operating system 165. Operating system 165 may interact with application 160 such that when client 140 sees information such as, for example, email messages stored in local client functionality component 120 via user interface 155, the information may appear to be from local drives 170. Additionally, if offsite centralized data center 110 hosts features for application 160 such as quarantined mail, the features may appear to be local to client 140 when interacting with user interface 155 of application 160. For example, a quarantined mail folder hosted by offsite centralized data center 110 may appear to be a local mail folder to client 140 when interacting with user interface 155 of application 160. Thus, data stored in local client functionality component 120 may appear to be local data to client 140, when in reality the data maybe remotely hosted by offsite centralized data center 11 0.

For client 140 to access resources, such as information or features stored in local functionality component 120 of offsite centralized data center 110, a user may need one user name and password. One user name and password to access both may be an alternative to requiring a separate user name and password to access local information and a separate offsite centralized data center user name and password to access the shared resources.

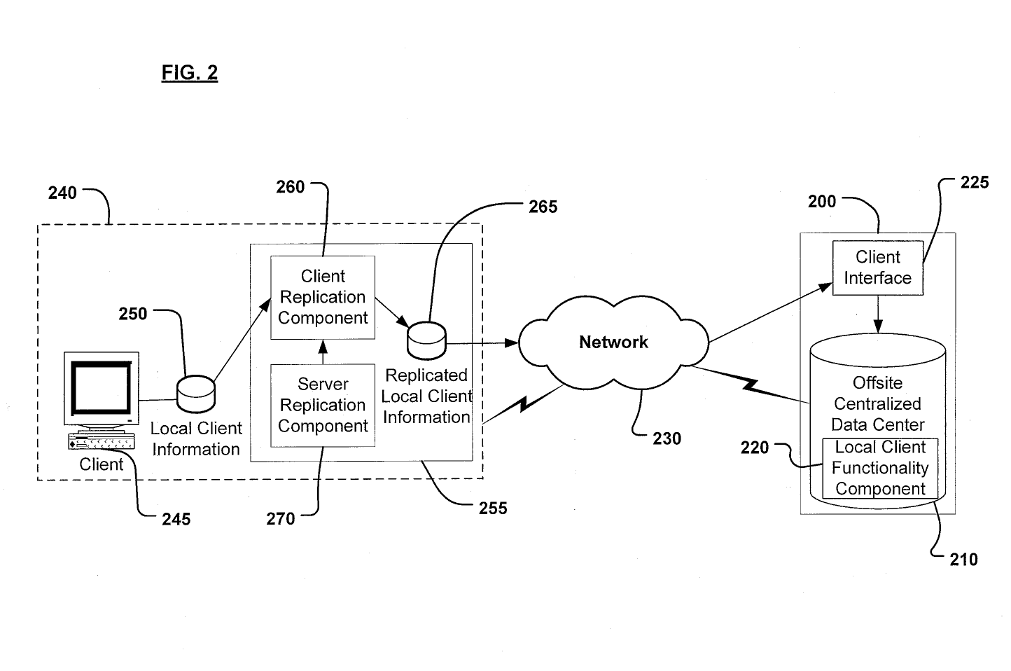

FIG. 2 depicts another example embodiment of a server 200 adapted to provide local client functionality. Server 200 includes a client interface 225. Client interface 225 may receive replicated local client information 265 from a client 245. Server 200 further includes an offsite centralized data center 210 that may be adapted to remotely host replicated local client information 265 in communication with client interface 225. Offsite centralized data center 210 may receive replicated local client information 265 from client interface 225. Offsite centralized data center 210 may be, for example, an enhanced database that may include a local client functionality component 220 stored therein. Offsite centralized data center 210 may be networked with one or more offsite centralized data centers. Networking multiple offsite centralized data centers may provide an increased ability to remotely host additional client functionality. Additionally, the networked offsite centralized data centers may function like distributed databases function when networked together. Offsite centralized data center 210 may store replicated local client information 265 in local client functionality component 220 in a systematic way such that it may be easily accessed by a client or on the clients behalf, for example, when filtering email for the client. Replicated local client information 265 may include, for example, domain names, passwords, email addresses, email messages, calendars, and contacts. Replicated local client information 265 may also include, for example, additional data such as word processing documents or software programs.

FIG. 2 further illustrates an on-premise network 240 including client 245. Client 245 may have a repository of local client information 250 stored in, for example, a memory drive of a computer. Local client information 250 may include, for example, emails, usernames, domain names, passwords, email messages, calendars, contacts, data such as word processing documents and even on-premise application features. On-premise network 240 further includes an on-premise client server 255. On-premise client server 255 includes a client replication component 260 and a server replication component 270. Client replication component 260 may produce replicated local client information 265 that may include, for example, in flight data corresponding to local client information 250. Replicated local client information 265 may be received by client interface 225 and hosted by offsite centralized data center 210. FIG. 2 illustrates an example embodiment of on-premise network 240. As one with ordinary skill in the art would understand, client 245 may include a computer with a replication software application that may perform the functions of on-premise client server 255. Additionally, one with ordinary skill in the art would understand there may be numerous instances of on-premise client server 255 in operative communication that may co-operate to perform the functions of a single instance of on-premise client server 255.

Local client information 250 may be replicated by client replication component 260 using, for example, a logical replication scheme or a physical based replication scheme. The logical replication scheme may include client replication component 260 interacting with local client information 250 such that if local client information 250 includes email messages, the logical replication scheme may sort through the messages and replicate new messages to push to offsite centralized data center 210. Alternatively, the physical based replication scheme may include client replication component 260 interacting with local client information 250 such that if local client information 250 includes email messages, the physical based replication scheme replicates changes to messages to push to offsite centralized data center 210.

Offsite centralized data center 210 may provide archiving of replicated local client information 265. If replicated local client information 265 includes email messages, the email messages may be archived in offsite centralized data center 210 by redirecting the flow of the email. For example, email messages may be blind carbon copied to offsite centralized data center 210. Also, client 245 may grant permission to offsite centralized data center 210 to access email messages in its inbox by pushing the messages to offsite centralized data center 210. This similar technique can be used for other information such as calendars, contacts, and tasks. Thus, client 245 may push replicated local client information 265 to offsite centralized data center 210 by granting access to offsite centralized data center such that replicated local client information 265 may be archived.

In communication with client replication component 260 may be server replication component 270. Server replication component 270 may provide feedback to client replication component 260 regarding synchronization of replicated local client information 265. For example, server replication component 270 may provide feedback to client replication component 260 on whether offsite centralized data center 210 received replicated local client information 265.

FIG. 2 further depicts one example of the flow of local client information 250 from client 245 to offsite centralized data center 210. As illustrated in FIG. 2, on-premise network 240 may be in communication with offsite centralized data center 210 via a network 230. Client replication component 260 may collect local client information 250 from client 245 and produce replicated local client information 265 therefrom. Replicated local client information 265 may be pushed to client interface 225 via network 230. Client interface 225, which is in communication with offsite centralized data center 210, may send replicated local client information 265 to offsite centralized data center 210 where replicated local client information 265 may be stored in local client functionality component 220. Offsite centralized data center 210 may provide feedback on the status of the synchronization of replicated local client information 265 at the offsite centralized data center to server replication component 270 via network 230. Server replication component 270, as discussed above, may communicate this received feedback to client replication component 260.

As discussed above and shown by the flow of information in FIG. 2, replicated local client information 265 may be pushed to offsite centralized data center 210. By pushing the information to offsite centralized data center 210, on-premise network 240 may be more secure. For example, if on-premise network 240 pushes replicated local client information 265 to offsite centralized data center 210, on-premise network 240 may not need to open a connection to network 230. Thus, just replicated local client information 265 may be compromised via network 230 instead of information at on-premise network 240. Additionally, a firewall, for example, may be present at an outbound connection of on-premise network 240 to network 230 to further enhance security.

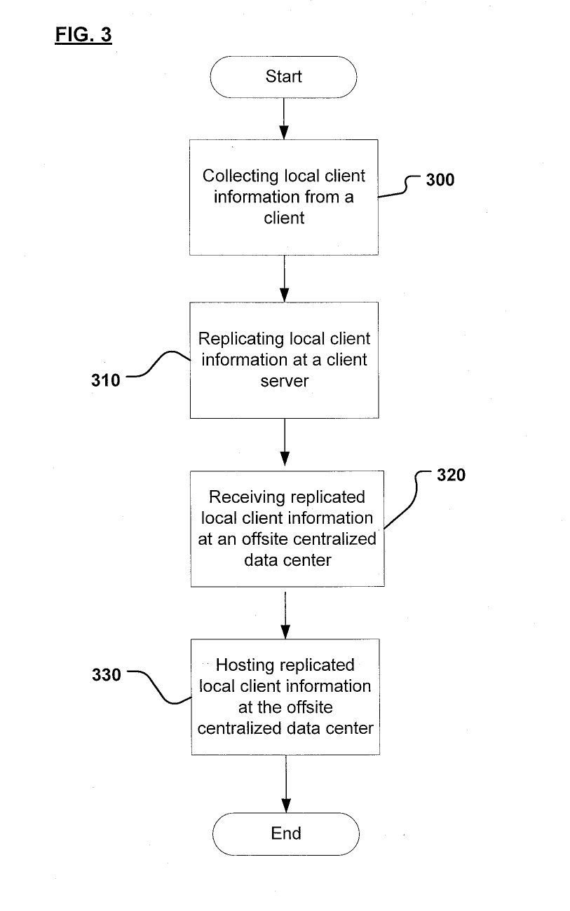

FIG. 3 depicts a flow diagram that illustrates providing local client functionality remotely according to one embodiment. As shown in FIG. 3, at 300, local client information including, for example, emails, domain names, passwords, email addresses, email messages, calendars, contacts, and documents may be collected from a client.

At 310, a client server may replicate local client information. The local client information may be replicated using a logical replication scheme, for example, an entire email message may be replicated. Alternatively, the local client information may be replicated using a physical based replication scheme, for example, changes to an email message may be replicated.

At 320, an offsite centralized data center may receive the replicated local client information. The offsite centralized data center may directly receive the replicated local client information. Alternatively, the server may include a client interface in communication with the offsite centralized such that the client interface receives the replicated local client information from the client and the offsite centralized data center receives the replicated local client information from the client interface.

At 330, the offsite centralized data center may host the replicated local client information. In one embodiment, the offsite centralized data center may archive the hosted replicated local client information for a client. Additionally, a client may access the replicated local client information hosted by the offsite centralized data center. The replicated local client information accessed may appear local to the client. For example, the client may believe the accessed replicated local client information resides on a local drive rather than at the offsite centralized data center.

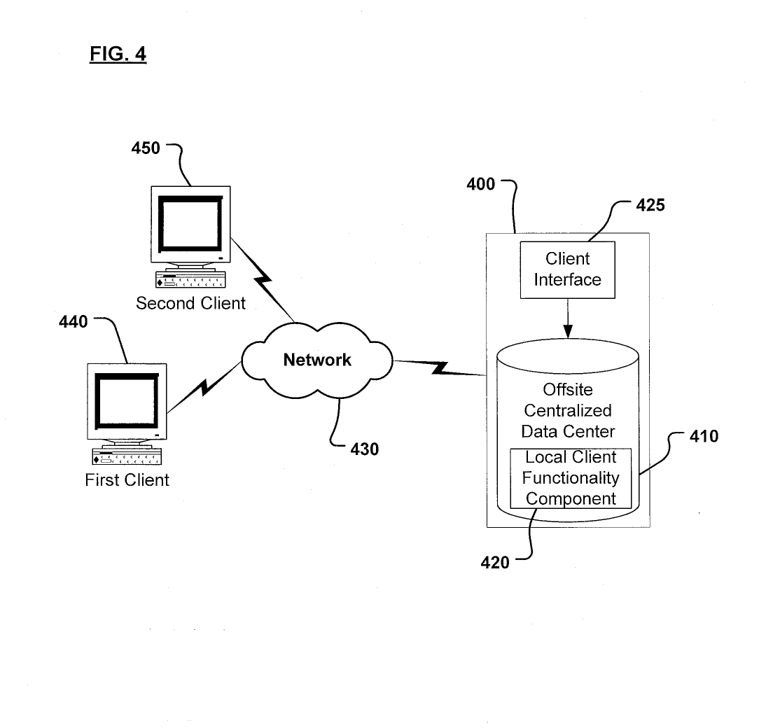

FIG. 4 depicts an offsite centralized data center 410 in communication with a first client 440 and a second client 450. As shown in FIG. 4, a server 400 including offsite centralized data center 410 may be in communication with a network 430. Offsite centralized data center 410 may remotely host information stored in a local client functionality component 420 for first client 440. First client 440 may also be in communication with network 430 to access the hosted information. First client 440 may also establish a first relationship with offsite centralized data center 410 via network 430. The first relationship may include, for example, common industry, common business practices, and/or common security authorization. The first relationship may be authenticated, for example, by specific usernames and passwords. Alternatively, the first relationship may be authenticated, for example, by security certificates such as public and private key codes that may be managed by offsite centralized data center 410.

To broker information from offsite centralized data center 410 to additional clients, a second client 450 may also be in communication with network 430. Second client 450 may establish a second relationship with offsite centralized data center 410. The second relationship may include, for example, common industry, common business practices, and/or common security authorization. The second relationship may be authenticated, for example, by specific usernames and passwords. Alternatively, the second relationship may be authenticated, for example, by security certificates such as public and private key codes that may be managed by offsite centralized data center 410.

Offsite centralized data center 410 may compare the first relationship established by first client 440 with the second relationship established by second client 450. Offsite centralized data center 410 may broker or share resources or information located at offsite centralized data center 410 if the first relationship established by first client 440 with offsite centralized data center 410 corresponds to the second relationship established by second client 450 with offsite centralized data center 410. By allowing first client 440 to share information with second client 450 via offsite centralized data center 410, a common security thread may be implemented at offsite centralized data center 410 that may better secure the resource or information shared. Additionally, by allowing information to be shared at offsite centralized data center 410, first client 440 may reduce a security breach by second client 450 to information first client 440 may not want to share with second client 450. For example, if first client 440 pushes the information it wants to share to offsite centralized data center 410, second client 450 may access the pushed information at offsite centralized data center 410 instead of additional information that may be locally stored by first client 440.

Additionally, if the first relationship established by first client 440 corresponds to the second relationship established by second client 450, offsite centralized data center 410 may also generate a template to handle the information hosted at offsite centralized data center 410 based on the corresponding relationship. For example, first client 440 may establish a first relationship with offsite centralized data center 410 as a law firm. Similarly, second client 450 may establish a second relationship with offsite centralized data center 410 as a law firm. Because the first relationship and second relationship match, offsite centralized data center 410 may generate a template based on this commonality. The template may be used to handle information hosted to first client 440 and second client 450 in a similar fashion. For example, the common template may archive email pushed to offsite centralized data center 410 in a similar fashion based on legal document discovery laws that may govern both first client 440 and second client 450.

FIG. 4 illustrates brokering between two clients and is by no means limiting, for example, additional clients may establish relationships with the data center such that resources stored at offsite centralized data center 410 may be brokered to them as well.

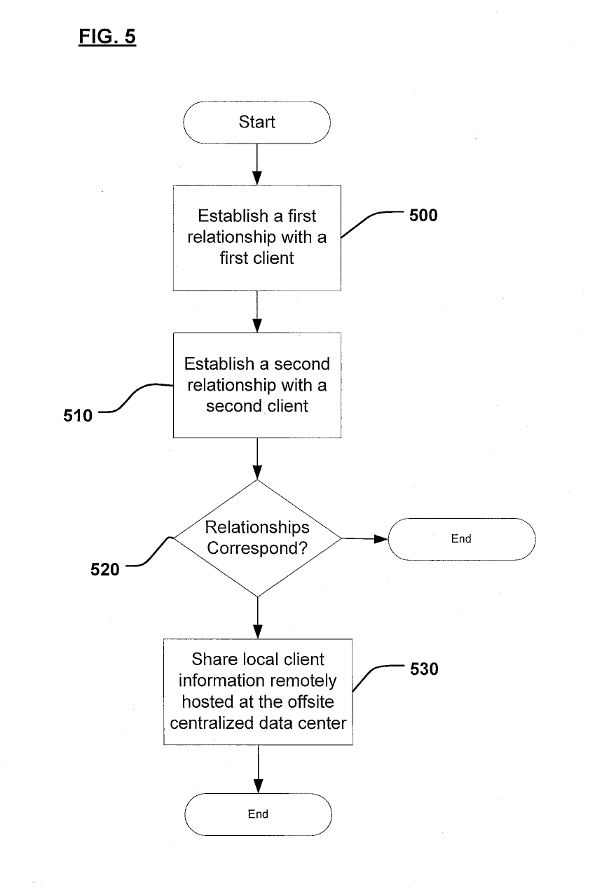

FIG. 5 depicts a flow diagram that illustrates brokering multiple clients via a centralized data center according to one embodiment. As shown in FIG. 5, at 500, the offsite centralized data center may establish a first relationship with a first client. The first relationship may include, for example, common industry, common business practices, and/or common security authorization. The first relationship may be authenticated, for example, by specific usernames and passwords. Alternatively, the first relationship may be authenticated, for example, by security certificates, such as public and private key codes. It may be recognized by one skilled in the art, that the first client may establish the relationship with the offsite centralized data center as well.

Similarly, at 510, the offsite centralized data center may establish a second relationship with a second client. The second relationship may include, for example, common industry, common business practices, and common security authorization. The second relationship may be authenticated, for example, by specific usernames and passwords. Alternatively, the second relationship may be authenticated, for example, by security certificates, such as public and private key codes. It may be recognized by one skilled in the art, that the second client may establish the relationship with the offsite centralized data center as well.

At 520, the data center may decide whether the first relationship established by the first client at 500 corresponds with the second relationship established by the second client in step 510. For example, first and second client may be common industries or common security authorizations. If the first relationship and second relationship do not correspond, for example, the security certificates do not match, brokering ends.

If the first relationship and second relationship correspond at 520, then at 530 the offsite centralized data center shares local client information remotely between the first client and second client. The replicated local client information may include, for example, emails, domain names, passwords, email addresses, email messages, calendars, contacts, and documents. Sharing the information at 530, may include, for example making the information accessible to both the first and second clients for a meeting. Sharing at 530 may also include sharing network strategies, for example, sharing policies regarding email disposal.

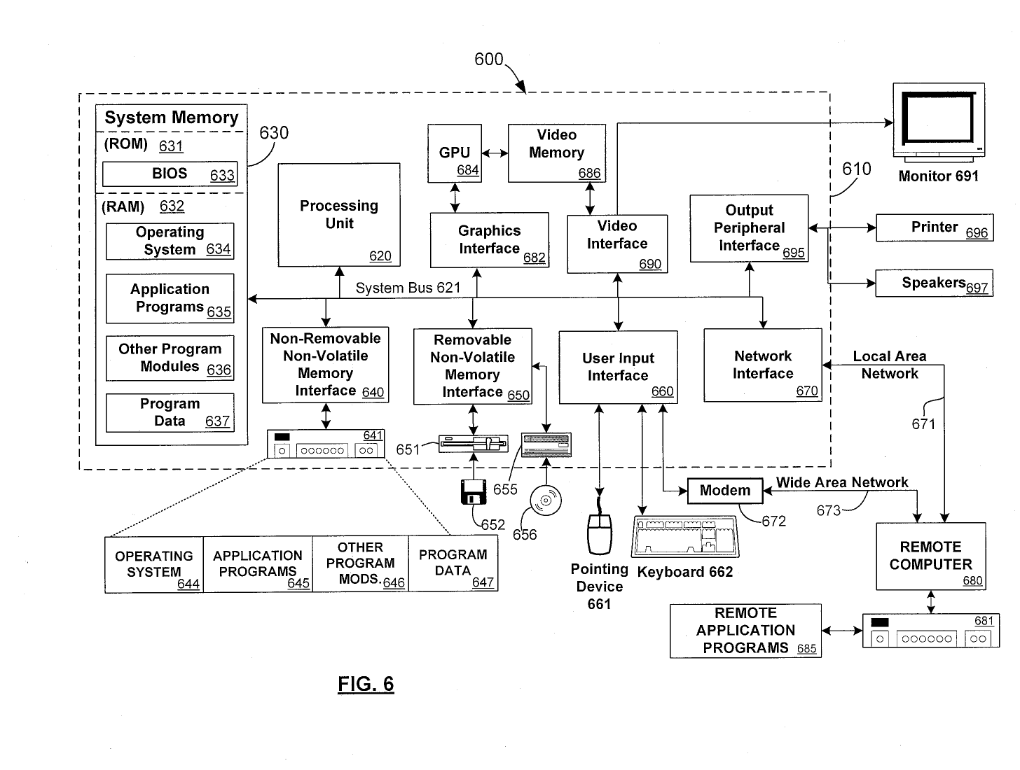

FIG. 6 shows an exemplary computing environment in which aspects of the example embodiments may be implemented. Computing system environment 600 is only one example of a suitable computing environment and is not intended to suggest any limitation as to the scope of use or functionality of the described example embodiments. Neither should computing environment 600 be interpreted as having any dependency or requirement relating to any one or combination of components illustrated in exemplary computing environment 600.

The example embodiments are operational with numerous other general purpose or special purpose computing system environments or configurations. Examples of well known computing systems, environments, and/or configurations that may be suitable for use with the example embodiments include, but are not limited to, personal computers, server computers, hand-held or laptop devices, multiprocessor systems, microprocessor-based systems, set top boxes, programmable consumer electronics, network PCs, minicomputers, mainframe computers, embedded systems, distributed computing environments that include any of the above systems or devices, and the like.

The example embodiments may be described in the general context of computer-executable instructions, such as program modules, being executed by a computer. Generally, program modules include routines, programs, objects, components, data structures, etc. that perform particular tasks or implement particular abstract data types. The example embodiments also may be practiced in distributed computing environments where tasks are performed by remote processing devices that are linked through a communications network or other data transmission medium. In a distributed computing environment, program modules and other data may be located in both local and remote computer storage media including memory storage devices.

With reference to FIG. 6, an exemplary system for implementing the example embodiments includes a general purpose computing device in the form of a computer 610. Components of computer 610 may include, but are not limited to, a processing unit 620, a system memory 630, and a system bus 621 that couples various system components including the system memory to processing unit 620. Processing unit 620 may represent multiple logical processing units such as those supported on a multi-threaded processor. System bus 621 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus (also known as Mezzanine bus). System bus 621 may also be implemented as a point-to-point connection, switching fabric, or the like, among the communicating devices.

Computer 610 typically includes a variety of computer readable media. Computer readable media can be any available media that can be accessed by computer 660 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can accessed by computer 610. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

System memory 630 includes computer storage media in the form of volatile and/or nonvolatile memory such as read only memory (ROM) 631 and random access memory (RAM) 632. A basic input/output system 633 (BIOS), containing the basic routines that help to transfer information between elements within computer 610, such as during start-up, is typically stored in ROM 631. RAM 632 typically contains data and/or program modules that are immediately accessible to and/or presently being operated on by processing unit 620. By way of example, and not limitation, FIG. 6 illustrates operating system 634, application programs 635, other program modules 636, and program data 637.

Computer 610 may also include other removable/non-removable, volatile/nonvolatile computer storage media. By way of example only, FIG. 6 illustrates a hard disk drive 640 that reads from or writes to non-removable, nonvolatile magnetic media, a magnetic disk drive 651 that reads from or writes to a removable, nonvolatile magnetic disk 652, and an optical disk drive 655 that reads from or writes to a removable, nonvolatile optical disk 656, such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. Hard disk drive 641 is typically connected to system bus 621 through a non-removable memory interface such as interface 640, and magnetic disk drive 651 and optical disk drive 655 are typically connected to system bus 621 by a removable memory interface, such as interface 650.

The drives and their associated computer storage media discussed above and illustrated in FIG. 6, provide storage of computer readable instructions, data structures, program modules and other data for computer 610. In FIG. 6, for example, hard disk drive 641 is illustrated as storing operating system 644, application programs 645, other program modules 646, and program data 647. Note that these components can either be the same as or different from operating system 634, application programs 635, other program modules 636, and program data 637. Operating system 644, application programs 645, other program modules 646, and program data 647 are given different numbers here to illustrate that, at a minimum, they are different copies. A user may enter commands and information into computer 610 through input devices such as a keyboard 662 and pointing device 661, commonly referred to as a mouse, trackball or touch pad. Other input devices (not shown) may include a microphone, joystick, game pad, satellite dish, scanner, or the like. These and other input devices are often connected to processing unit 620 through a user input interface 660 that is coupled to the system bus, but may be connected by other interface and bus structures, such as a parallel port, game port or a universal serial bus (USB). A monitor 691 or other type of display device is also connected to system bus 621 via an interface, such as a video interface 690. In addition to the monitor, computers may also include other peripheral output devices such as speakers 697 and printer 696, which may be connected through an output peripheral interface 695.

Computer 610 may operate in a networked environment using logical connections to one or more remote computers, such as a remote computer 680. Remote computer 680 may be a personal computer, a server, a router, a network PC, a peer device or other common network node, and typically includes many or all of the elements described above relative to computer 610, although only a memory storage device 681 has been illustrated in FIG. 6. The logical connections depicted in FIG. 6 include a local area network (LAN) 671 and a wide area network (WAN) 673, but may also include other networks. Such networking environments are commonplace in offices, enterprise-wide computer networks, intranets and the Internet.

When used in a LAN networking environment, computer 610 is connected to LAN 671 through a network interface or adapter 670. When used in a WAN networking environment, computer 610 typically includes a modem 672 or other means for establishing communications over WAN 673, such as the Internet. Modem 672, which may be internal or external, may be connected to system bus 621 via user input interface 660, or other appropriate mechanism. In a networked environment, program modules depicted relative to computer 610, or portions thereof, may be stored in the remote memory storage device. By way of example, and not limitation, FIG. 6 illustrates remote application programs 685 as residing on memory device 681. It will be appreciated that the network connections shown are exemplary and other means of establishing a communications link between the computers may be used.

Computing environment 600 typically includes at least some form of computer readable media. Computer readable media can be any available media that can be accessed by computing environment 600. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by computing environment 600. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A server adapted to provide client functionality, comprising:
an offsite centralized data center; and
a local client functionality component stored in said offsite centralized data center, wherein said offsite centralized data center remotely hosts said local client functionality component.

2. The server of claim 1, further comprising:
a first client in communication with a network, wherein said first client establishes a first relationship with said offsite centralized data center via said network; and
a second client in communication with said network, wherein said second client establishes a second relationship with said offsite centralized data center, wherein said offsite centralized data center shares said local client functionality component with said second client interface if said first relationship corresponds to said second relationship.

3. The server of claim 2, wherein said first relationship and said second relationship comprises at least one of the following: common industry, common business practices, and common security authorization.

4. The server of claim 2, wherein said local client functionality component remotely hosted at said offsite centralized data center appears local to said first and second client.

5. The server of claim 1, wherein said local client functionality component comprises data.

6. The server of claim 5, wherein said data comprises at least one of the following: electronic messages, calendars, contacts, documents, passwords, domain names, and instant messages.

7. A method for providing server functionality, comprising:
receiving a replicated local client information at an offsite centralized data center; and
hosting said replicated local client information at said offsite centralized data center.

8. The method of claim 7, further comprising:
establishing a first relationship with a first client, wherein said first client is in communication with a network;
establishing a second relationship with a second client, wherein said second client is in communication with said network; and
sharing said replicated local client information remotely hosted at said offsite centralized data center with said first client and said second client, if said first relationship corresponds to said second relationship.

9. The method of claim 8, wherein said replicated local client information remotely hosted at said offsite centralized data center appears local to said first and second clients.

10. The method of claim 7, further comprising an on-premise network in communication with said offsite centralized data center, wherein said on-premise network comprises a client in communication with a client server.

11. The method of claim 10, wherein said client server comprises:
a client replication component adapted to collect a local client information from said client, wherein said client replication component produces said replicated local client information using said collected local client information; and
a server replication component adapted to provide feedback to said client replication component, wherein said feedback includes whether said offsite centralized data center received said replicated local client information.

12. The method of claim 7, further comprising archiving said replicated local client information at said offsite centralized data center.

13. The method of claim 12, wherein said replicated local client information comprises at least one of the following: electronic messages, calendars, contacts, documents, passwords, domain names, and instant messages.

14. A server adapted to provide client functionality, comprising:
a client interface, wherein said client interface receives a replicated local client information from a first client; and
an offsite centralized data center adapted to remotely host said replicated local client information in communication with said client interface, wherein said offsite centralized data center receives said replicated local client information from said client interface.

15. The server of claim 14, wherein said replicated local client information remotely hosted at said offsite centralized data center appears local to said first client.

16. The server of claim 14, wherein said replicated local client information is pushed to said offsite centralized data center via a network to reduce security risks to said first client.

17. The server of claim 14, further comprising:
a client server in communication with said first client, wherein said client server comprises a client replication component adapted to collect a local client information from said first client, and wherein said client replication component produces said replicated local client information using said collected local client information; and
a server replication component adapted to provide feedback to said client replication component, wherein said feedback includes whether said offsite centralized data center received said replicated local client information.

18. The server system of claim 14, wherein said first client establishes a first relationship with said offsite centralized data center via a network; and
a second client in communication with said network, wherein said second client establishes a second relationship with said offsite centralized data center via said network, wherein said offsite centralized data center shares said replicated local client information with said second client if said first relationship corresponds to said second relationship.

19. The server of claim 14, wherein said offsite centralized data center archives said replicated local client information.

20. The server system of claim 19, wherein said replicated local client information comprises at least one of the following: electronic messages, calendars, contacts, documents, passwords, domain names, and instant messages.
